(19) United States
(12) Patent Application Publication
(10) Pub. No.: US 2026/0142834 A1
(43) Pub. Date: May 21, 2026

(54) DEVICE FOR TESTING SIGNATURE VERIFICATION OPERATION AND OPERATION METHOD THEREOF

(71) Applicant: SAMSUNG ELECTRONICS CO., LTD., Suwon-si (KR)

(72) Inventors: Gwangbae CHOI, Suwon-si (KR); Jisoo KIM, Suwon-si (KR); Mungyu BAE, Suwon-si (KR); Younsung CHU, Suwon-si (KR)

(73) Assignee: SAMSUNG ELECTRONICS CO., LTD., Suwon-si (KR)

(21) Appl. No.: 19/313,272

(22) Filed: Aug. 28, 2025

(30) Foreign Application Priority Data
Nov. 19, 2024 (KR) 10-2024-0165426

(51) Int. Cl. H04L 9/32; H04L 9/00; H04L 9/08

(52) U.S. Cl. CPC H04L 9/3247; H04L 9/0869; H04L 9/50

(57) ABSTRACT

A method of testing a signature verification system including a computing device and a memory device, may include: generating a seed and a signature including first type codes and a leaf node index, wherein the first type codes include height information of a hash chain and height information of a Merkle tree; generating first intermediate values of the hash chain, a first hash function seed, and first node values of the Merkle tree using a deterministic function, based on the seed; generating a message; performing, by the computing device, a hash operation on the message; and generating a value of a first leaf node by performing hash chain operations, wherein the hash chain operations take the first intermediate values and the first hash function seed as inputs.

### CROSS-REFERENCE TO RELATED APPLICATIONS

This application claims priority under 35 U.S.C. § 119 to Korean Patent Application No. 10-2024-0165426 filed on November 19, 2024, in the Korean Intellectual Property Office, the disclosures of which are incorporated by reference herein in their entireties.

### BACKGROUND

The present disclosure relates to a digital signature, and more particularly, relates to a device for testing a verification operation of a digital signature, and an operating method thereof.

To ensure that only normal firmware is executed on an electronic device such as a processor or a memory device, signature verification of the firmware is used. To identify that the firmware has not been tampered, through signature verification, a signature verification algorithm is verified as operating normally. In this case, a message, a signature, and a public key for which the results of signature verification are already known in advance in the firmware are referred to as “test vectors”. To test whether the signature verification algorithm is normal, a known-answer-test is performed by using the test vectors.

In the case of related art firmware, the signature verification has been performed by using a signature algorithm such as Rivest-Shamir-Adleman (RSA) or Elliptic Curve Digital Signature Algorithm (ECDSA). The U.S. National Security Agency (NSA) has introduced the Commercial National Security Algorithm (CNSA) 2.0, which is a security standard, to prepare for future attacks using quantum computing. Accordingly, signature algorithms may be replaced with a signature algorithm such as the Leighton-Micali Signature (LMS) method. However, compared to RSA or ECDSA methods, the signature size of the signature algorithm of LMS method may be greatly increased. Accordingly, a test method for signature verification operation capable of minimizing the size increase of the firmware by increasing the signature size is being discussed.

### SUMMARY

Provided are a signature verification system that generates a test vector for minimizing the size increase of firmware in a test operation of a signature verification operation and performs signature verification on the a test vector, and an operating method thereof.

According to an aspect of the disclosure, a method of testing a signature verification system including a computing device and a memory device, may include: generating, by the computing device, a seed and a signature including first type codes and a leaf node index, wherein the first type codes include height information of a hash chain and height information of a Merkle tree; generating, by the computing device, first intermediate values of the hash chain, a first hash function seed, and first node values of the Merkle tree using a deterministic function, based on the seed; generating, by the computing device, a message; performing, by the computing device, a hash operation on the message; generating, by the computing device, a value of a first leaf node by performing hash chain operations, wherein the hash chain operations take the first intermediate values and the first hash function seed as inputs, and wherein counts of the hash chain operations are determined based on a value obtained by performing the hash operation on the message; generating, by the computing device, a value of a first root node by performing Merkle tree operations on the value of the first leaf node and the first node values based on the leaf node index; generating, by the computing device, a public key including a root value identical to the value of the first root node; and providing, by the computing device, the signature, the message, and the public key to the memory device.

According to an aspect of the disclosure, a signature verification system may include: a signature generator configured to generate a seed and a signature; a computing circuit configured to generate first data using a deterministic function, based on the seed; a key generator configured to: determine a first root value based on a message, the signature, and the first data; and generate a public key including the first root value; a non-volatile memory configured to store the seed, the signature, the message, and the public key; and a verification device configured to: receive the seed, the signature, the message, and the public key from the non-volatile memory; determine second data using the deterministic function, based on the seed; determine a second root value based on the signature, the message, and the second data; and determine whether a signature verification operation is normal, based on whether the second root value is identical to the first root value in the public key.

According to an aspect of the disclosure, a computing device may include: a signature generator configured to generate a seed and a signature including first type codes and a leaf node index; a computing circuit configured to use a deterministic function to generate first intermediate values, a first hash function seed, and first node values of path nodes, based on the seed; and a key generator configured to: generate a value of a first leaf node by performing hash chain operations, wherein the hash chain operations take the first intermediate values and the first hash function seed as inputs, based on the first type codes; generate a value of a first root node by performing Merkle tree operations on the value of the first leaf node and the first node values based on the first type codes and the leaf node index; and generate a public key including a root value identical to the value of the first root node.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a signature verification system, according to one or more embodiments of the present disclosure;

FIG. 2 is a flowchart illustrating a method for performing a signature operation on a message, according to one or more embodiments of the present disclosure;

FIG. 3 is a flowchart illustrating a method for performing a signature verification operation of verifying a signature, according to one or more embodiments of the present disclosure;

FIG. 4 is a diagram illustrating hash chain operations and a signature generation operation, according to one or more embodiments of the present disclosure;

FIG. 5 is a diagram illustrating an operation of generating Merkle tree operations and a value of a root node, according to one or more embodiments of the present disclosure;

FIG. 6 is a diagram showing a structure of a signature, according to one or more embodiments of the present disclosure;

FIG. 7 is a diagram showing a structure of a public key, according to one or more embodiments of the present disclosure;

FIG. 8 is a diagram illustrating a signature verification system for testing a signature verification operation, according to one or more embodiments of the present disclosure;

FIG. 9 is a diagram illustrating a test vector generating method, according to one or more embodiments of the present disclosure;

FIG. 10 is a flowchart illustrating a test vector generating method of FIG. 9, according to one or more embodiments of the present disclosure;

FIG. 11 is a diagram illustrating a deterministic function based on the seed of FIG. 10, according to one or more embodiments of the present disclosure;

FIG. 12 is a diagram illustrating a method in which a memory device tests a signature verification operation, according to one or more embodiments of the present disclosure;

FIG. 13 is a diagram illustrating hash chain operations when the signature verification system of FIG. 8 tests a signature verification operation, according to one or more embodiments of the present disclosure;

FIG. 14 is a diagram illustrating Merkle tree operations when the signature verification system of FIG. 8 tests a signature verification operation, according to one or more embodiments of the present disclosure; and

FIG. 15 is a diagram illustrating a firmware signature verification system 2000, according to one or more embodiments of the present disclosure.

### DETAILED DESCRIPTION

Hereinafter, embodiments of the present disclosure may be described in detail and clearly to such an extent that an ordinary one in the art easily implements the present disclosure.

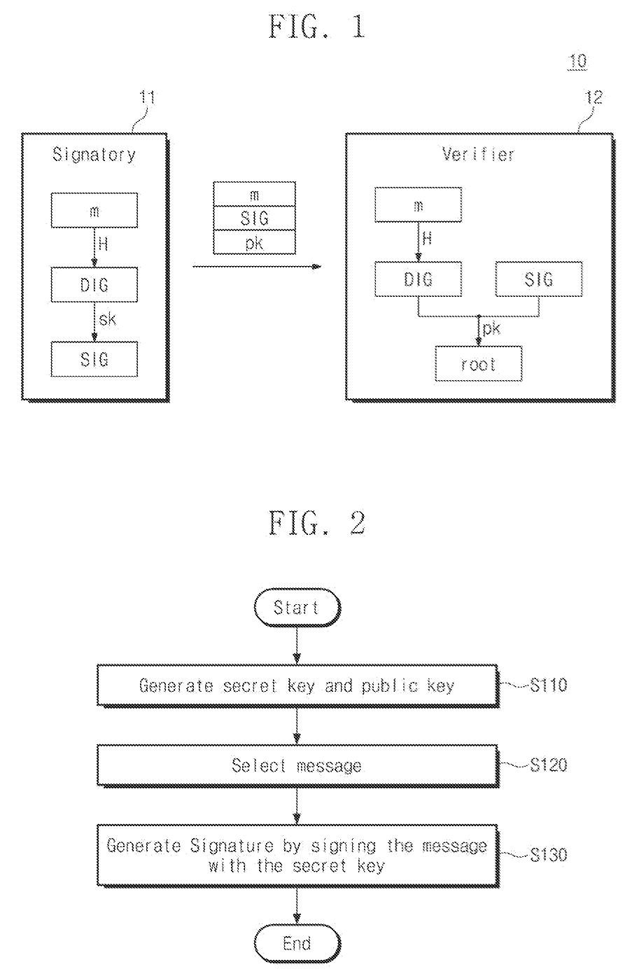

FIG. 1 is a diagram illustrating a signature verification system, according to one or more embodiments of the present disclosure.

Referring to FIG. 1, a signature verification system 10 may include a signatory 11 and a verifier 12.

The signatory 11 may be configured to deliver a message ‘m’, a signature SIG, and a public key pk to the verifier 12.

The signatory 11 may be configured to generate a secret key sk and the public key pk. For example, the signatory 11 may randomly generate the secret key sk depending on a determined parameter. For example, the signatory 11 may generate the public key pk based on determined parameters and the secret key sk.

The signatory 11 may be configured to select the message ‘m’. For example, the signatory 11 may be configured to select the message ‘m’, on which a signature operation is to be performed, based on an external signal.

The signatory 11 may be configured to generate the signature SIG by performing the signature operation on the message ‘m’. For example, the signatory 11 may be configured to perform the signature operation on the message ‘m’ by using the secret key sk. For example, the signatory 11 may be configured to generate the signature SIG by performing the signature operation on the message ‘m’.

According to some embodiments, the signatory 11 may be configured to generate a digest DIG by performing a hash operation on the message ‘m’. For example, the hash operation may be an operation of receiving data of an arbitrary size and returning a value of a fixed size. For example, the fixed size output through the hash operation may vary depending on an algorithm of the hash operation. For example, the hash operation may generate different output values for different input values. For example, the hash operation may be an operation according to a secure hash algorithm (SHA). For example, the secure hash algorithm may include SHA-256, SHA-256/192, SHAKE256/256, and SHAKE256/192.

For example, the signatory 11 may be configured to generate the signature SIG by performing an encryption operation on the digest DIG by using the secret key sk. For example, the encryption operation may be an operation according to a signature algorithm. For example, the signature algorithm may include Digital Signature Algorithm (DSA), Elliptic Curve Digital Signature Algorithm (ECDSA), Rivest-Shamir-Adleman (RSA), Leighton-Micali Signature (LMS), Leighton-Micali One-Time Signature (LMOTS), Extended Merkle Signature Scheme (XMSS), and the like. Detailed operations of the signature algorithm will be described later with reference to FIGS. 2 to 5.

The verifier 12 may be configured to perform a signature verification operation by receiving the message ‘m’, the signature SIG, and the public key pk from the signatory 11. For example, the verifier 12 may identify the integrity of the message ‘m’ and the fact that the message ‘m’ has been sent from the signatory 11, through the signature verification operation. For example, through the signature verification operation, the signatory 11 and the verifier 12 may prevent the denial of the fact of sending and receiving the message ‘m’.

The verifier 12 may be configured to perform the signature verification operation by performing a decryption operation on the message ‘m’ and the signature SIG by using the public key pk. For example, the decryption operation may be an operation according to the signature algorithm. For example, the signature algorithm of the decryption operation may be the same as the signature algorithm of the encryption operation. For example, the verifier 12 may be configured to generate the digest DIG by performing a hash operation on the message ‘m’, and to perform a decryption operation on the digest DIG and the signature SIG.

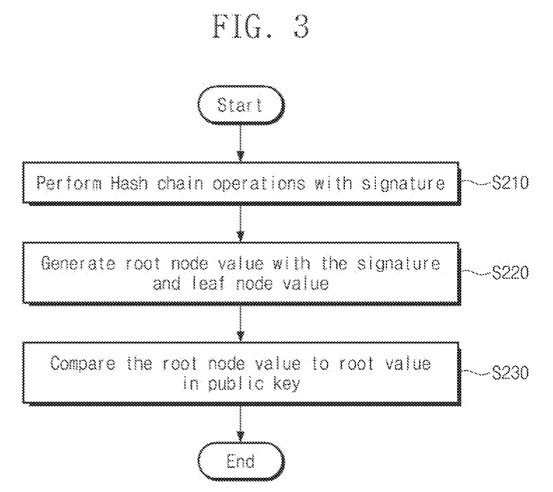

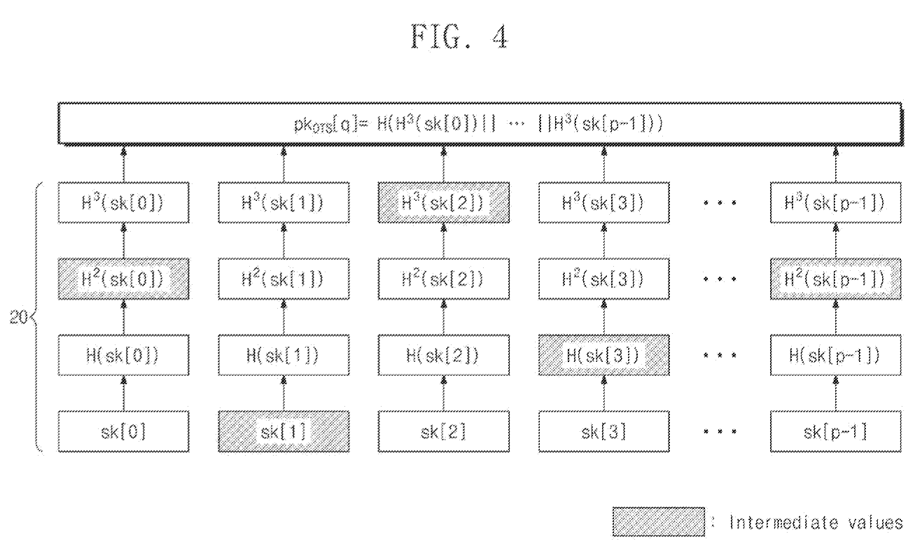

According to some embodiments, the verifier 12 may be configured to perform a signature verification operation based on whether a root value computed through the digest DIG and the signature SIG is the same as a value of a root node included in the public key pk. A detailed description of the signature verification operation will be provided later with reference to FIGS. 3 to 5.

FIG. 2 is a flowchart illustrating a method for performing a signature operation on a message, according to one or more embodiments of the present disclosure. Hereinafter, the description will be given with reference to FIG. 1.

Referring to FIG. 2, in operation S110, the secret key sk and the public key pk may be generated. According to one or more embodiments, the signatory 11 may generate the secret key sk and the public key pk based on set parameters. For example, the signatory 11 may generate the secret key sk based on a parameter, and may generate the public key pk based on the secret key sk. For example, the secret key sk and the public key pk may be generated depending on the structure of the hash chain and Merkle tree. For example, the signatory 11 may generate the public key pk by performing a hash chain operation and a Merkle tree operation on the secret key sk. For example, the signatory 11 may generate the secret key sk and the public key pk based on LMS and LMOTS signature methods.

In operation S120, the signatory 11 may select the message ‘m’. For example, the signatory 11 may select an arbitrary message ‘m’ based on an external signal. For example, the signatory 11 may select the data, which needs to be verified for integrity, as the message ‘m’. For example, the message ‘m’ may include a firmware image, a software update file, a security certificate, or transaction data.

In operation S130, the signature SIG may be generated. For example, the signatory 11 may sign the message ‘m’ by using the secret key sk. For example, the signatory 11 may generate the digest DIG by performing a hash operation on the message ‘m’, and then generate the signature SIG by performing an encryption operation on the digest DIG by using the secret key sk. For example, the encryption operation may be an operation according to the LMOTS signature method. For example, the LMOTS signature method may include hash chain operations.

FIG. 3 is a flowchart illustrating a method for performing a signature verification operation of verifying a signature, according to one or more embodiments of the present disclosure. Hereinafter, the description will be given with reference to FIG. 1.

In operation S210, a value of a one-time public key may be generated by performing hash chain operations on the signature SIG. For example, the hash chain operations may be operations that perform successive hash operations. For example, the signature SIG may include intermediate values. For example, the hash chain operations may be operations that generate multi-level hash values by repeatedly performing hash operations on intermediate values. For example, the hash values of each operation may be used as inputs to a hash operation of the next operation. For example, the hash chain operations may be operations according to a LMOTS signature method.

According to one or more embodiments, the verifier 12 may determine counts of hash chain operations based on a value obtained by the hash operation on the message ‘m’. For example, the verifier 12 may generate the digest DIG by performing a hash operation on the message ‘m’. For example, the verifier 12 may determine the counts of hash chain operations by splitting the digest DIG depending on a parameter included in the signature SIG. For example, the verifier 12 may perform the hash chain operations based on the counts of hash chain operations based on the intermediate values included in the signature SIG and the message ‘m’. Detailed descriptions of the hash chain operations will be described later with reference to FIG. 4.

According to one or more embodiments, the verifier 12 may generate a value of a one-time public key by performing a hash operation on the results of hash chain operations. For example, the one-time public key may be a public key in the LMOTS signature method. For example, a value obtained by performing a hash operation on the value of the one-time public key may be a value of a leaf node of a Merkle tree.

In operation S220, the value of the root node may be generated based on the signature SIG and the value of the leaf node. For example, the verifier 12 may generate the value of the root node by performing Merkle tree operations on the value of the leaf node. For example, the Merkle tree operations may be operations that generate a tree structure through hash operations. For example, the signature SIG may include first node values. For example, the first node values may be the values of the path nodes from a leaf node to the root node being the top node. For example, the Merkle tree operations may be operations that reach the root node by repeatedly performing hash operations between nodes adjacent to each other starting from a leaf node. For example, the Merkle tree operations may be operations according to the LMS signature method. Detailed descriptions of the Merkle tree operations will be described later with reference to FIG. 4.

In operation S230, a value of the root node may be compared with a root value included in the public key pk. For example, the verifier 12 may verify whether the value of the root node is the same as the root value included in the public key pk. For example, when the value of the root node is the same as the root value included in the public key pk, the verifier 12 may output that verification for the signature SIG is successful. For example, when the value of the root node is not the same as the root value included in the public key pk, the verifier 12 may output that verification for that signature SIG fails.

FIG. 4 is a diagram illustrating hash chain operations and a signature generation operation, according to one or more embodiments of the present disclosure.

A hash chain 20 may include secret keys sk[0] to sk[p-1] and hash chain intermediate values H(sk[0]) to H³(sk[p-1]).

According to one or more embodiments, referring to FIG. 1, the signatory 11 may be configured to generate the hash chain 20 based on parameters and the secret keys sk[0] to sk[p-1]. For example, the signatory 11 may be configured to generate the hash chain intermediate values H(sk[0]) to H³(sk[p-1]) and a one-time public key pk_{OTS} based on parameters and the secret keys sk[0] to sk[p-1]. For example, the signatory 11 may be configured to generate the hash chain intermediate values H(sk[0]) to H³(sk[p-1]) and the one-time public key pk_{OTS} based on type codes generated before the signature SIG is generated. For example, the signature SIG may include type codes, and the type codes may include parameters. For example, the signatory 11 may select the type codes based on an external signal before the secret key sk is generated. For example, the type codes may include information about the height of the hash chain 20. For example, the signatory 11 may perform hash chain operations on the secret keys sk[0] to sk[p-1] based on the height information of the hash chain 20. For example, the signatory 11 may generate hash chain intermediate values H(sk[0]) to H³(sk[p-1]) by performing hash chain operations on the secret keys sk[0] to sk[p-1] as much as the height of the hash chain 20. For example, the signatory 11 may generate a value of the one-time public key pk_{OTS} by performing a hash operation on the results of hash chain operations.

For example, the signatory 11 may be configured to split the digest DIG depending on the height information of the hash chain 20. For example, the signatory 11 may split the digest DIG into split digests having a size of 2 based on the height information of the hash chain 20. In this case, the height of the hash chain 20 may be “2²-1”. For example, when the digest DIG is split into split digests having the size of ‘w’, the height of the hash chain 20 may be “2^{w}-1”.

For example, the secret keys sk[0] to sk[p-1] may be values split depending on the height of the hash chain 20. For example, the number of secret keys may be ‘p’. For example, ‘p’ may be determined based on the size of the digest DIG and a size ‘w’ of the split digest.

According to one or more embodiments, the signatory 11 may generate first intermediate values included in the signature SIG based on split digests. For example, when the digest DIG is binary and the size of the split digest is 2, the split digests may have numbers from ‘00’ to ‘11’. For example, the counts of hash chain operations may be determined depending on numbers of split digests.

For example, referring to FIG. 4, when a first split digest is ‘10’, the signatory 11 may generate the 1-1st intermediate value H²(sk[0] by performing a hash operation twice on the first secret key sk[0]. When the second split digest is ‘00’, the signatory 11 may generate the 1-2nd intermediate value sk[1] by performing a hash operation zero times on the second secret key sk[1]. When the third split digest is ‘11’, the signatory 11 may generate the 1-3rd intermediate value H³(sk[2]) by performing a hash operation three times on the third secret key sk[2]. When the fourth split digest is ‘01’, the signatory 11 may generate the 1-4th intermediate value H(sk[3]) by performing a hash operation once on the fourth secret key sk[3]. When the p-th split digest is ‘10’, the signatory 11 may generate the first-p intermediate value H²(sk[p-1]) by performing a hash operation twice on the p-th secret key sk[p-1]. The first intermediate values may include the 1-1st intermediate value H²(sk[0]), the 1-2nd intermediate value sk[1], the 1-3rd intermediate value H³(sk[2]), the 1-4th intermediate value H(sk[3]), and the (1-p)-th intermediate value H²(sk[p-1]). That is, the signature SIG may include the 1-1st intermediate value H²(sk[0]), the 1-2nd intermediate value sk[1], the 1-3rd intermediate value H³(sk[2]), the 1-4th intermediate value H(sk[3]), and the (1-p)-th intermediate value H²(sk[p-1]).

FIG. 5 is a diagram illustrating an operation of generating Merkle tree operations and a value of a root node, according to one or more embodiments of the present disclosure.

Referring to FIG. 5, a Merkle tree 30 may include a root node T[1], intermediate nodes T[2] and T[3], and leaf nodes T[4] to T[7]. For example, the root node T[1] may be a node at the top of the Merkle tree 30. For example, the leaf nodes T[4] to T[7] may be nodes located at the bottom of the Merkle tree 30. For example, the intermediate nodes T[2] and T[3] may be nodes located between the root node T[1] and the leaf nodes T[4] to T[7]. For example, referring to FIG. 4, a value obtained by performing a hash operation on a value of a one-time public key pk_{OTS} may be a value of one of the leaf nodes T[4] to T[7] of the Merkle tree.

According to one or more embodiments, referring to FIG. 1, the signatory 11 may be configured to generate the Merkle tree 30 based on parameters and the one-time public key pk_{OTS}. For example, the signatory 11 may be configured to generate the root node T[1], the intermediate nodes T[2] and T[3], and the leaf nodes T[4] to T[7] based on the parameters and the one-time public key pk_{OTS}. For example, the signatory 11 may be configured to generate the Merkle tree 30 based on type codes generated before the signature SIG is generated. For example, the signature SIG may include type codes, and the type codes may include parameters. For example, the signatory 11 may select the type codes based on an external signal before the secret key sk is generated. For example, the type codes may include information about the height of the Merkle tree 30.

According to one or more embodiments, the number of leaf nodes T[4] to T[7] of the Merkle tree 30 may be determined based on the height information of the Merkle tree 30. For example, the signatory 11 may generate the Merkle tree 30 having a size of 2. In this case, the number of leaf nodes may be 2². For example, when the signatory 11 generates the Merkle tree 30 having a size of ‘h’, the number of leaf nodes may be 2^{h}.

For example, the leaf nodes T[4] to T[7] of the Merkle tree 30 may be generated based on different one-time public keys. For example, the signatory 11 may generate the one-time public keys through hash chain operations, as described in FIG. 4. For example, the signatory 11 may generate the leaf nodes T[4] to T[7] by different secret keys and different hash chains. For example, the signatory 11 may generate secret keys and hash chains as many as needed based on the height information of the Merkle tree 30. For example, the signatory 11 may generate the leaf nodes T[4] to T[7] by performing a hash operation on each of the generated one-time public keys.

According to one or more embodiments, the signatory 11 may perform Merkle tree operations on the leaf nodes T[4] to T[7]. For example, the signatory 11 may generate the values of the intermediate nodes T[2] and T[3] by performing hash operations on nodes respectively adjacent to values of the leaf nodes T[4] to T[7]. For example, the signatory 11 may generate the value of the root node T[1] by repeatedly performing hash operations on nodes respectively adjacent to values of the intermediate nodes T[2] and T[3].

For example, the signatory 11 may generate the value of the intermediate node T[2] by performing a hash operation on values of the leaf nodes T[4] and T[5]. For example, the signatory 11 may generate the value of the intermediate node T[3] by performing a hash operation on values of the leaf nodes T[6] and T[7]. For example, the signatory 11 may generate the value of the root node T[1] by performing a hash operation on values of the intermediate nodes T[2] and T[3].

According to one or more embodiments, the signatory 11 may use different one-time public keys whenever the message ‘m’ is signed. For example, the signatory 11 may use different one-time public keys with different hash chains for each signature. For example, when signing the message ‘m’ in FIG. 1, only the hash chain 20 and the one-time public key pk_{OTS} in FIG. 4 may be used.

For example, the signatory 11 in FIG. 4 may generate the value of the leaf node T[7] through a hash operation on the value of the one-time public key pk_{OTS}. For example, the signatory 11 may include a leaf node index and first node values in the signature SIG. For example, a leaf node index may include location information of the leaf node T[7]. For example, the first node values may be values of the path nodes T[2] and T[6] from the leaf node T[7], at which the signature is generated, to the root node T[1]. For example, the path nodes T[2] and T[6] may be nodes, at which a hash operation is required such that the leaf node T[7] reaches the root node T[1]. In other words, the signature SIG may include first intermediate values and first node values. For example, the signature SIG may include the 1-1st intermediate value H²(sk[0]), the 1-2nd intermediate value sk[1], the 1-3rd intermediate value H³(sk[2]), the 1-4th intermediate value H(sk[3]), and the (1-p)-th intermediate value H²(sk[p-1]). In other words, the signature SIG may include values of the 1-1st intermediate value H²(sk[0]), the 1-2nd intermediate value sk[1], the 1-3rd intermediate value H³(sk[2]), the 1-4th intermediate value H(sk[3]), the (1-p)-th intermediate value (H²(sk[p-1])), and the path nodes T[2] and T[6].

According to one or more embodiments, the signatory 11 may include type codes and the generated value of the root node T[1] in the public key pk. For example, the verifier 12 may determine whether type codes included in the signature SIG are the same as type codes included in the public key pk. For example, the verifier 12 may generate the digest DIG by performing a hash operation on a message. For example, the verifier 12 may generate the value of a one-time public key by performing hash chain operations on split digests based on the type codes. For example, the verifier 12 may generate a value of a leaf node by performing a hash operation on the value of the one-time public key. For example, the verifier 12 may generate the value of the root node by performing Merkle tree operations on the generated values of a leaf node and the first node values included in the signature SIG based on the leaf node index included in the signature SIG. For example, the verifier 12 may perform a signature verification operation by determining whether the generated value of the root node is the same as the value of the root node included in the public key pk.

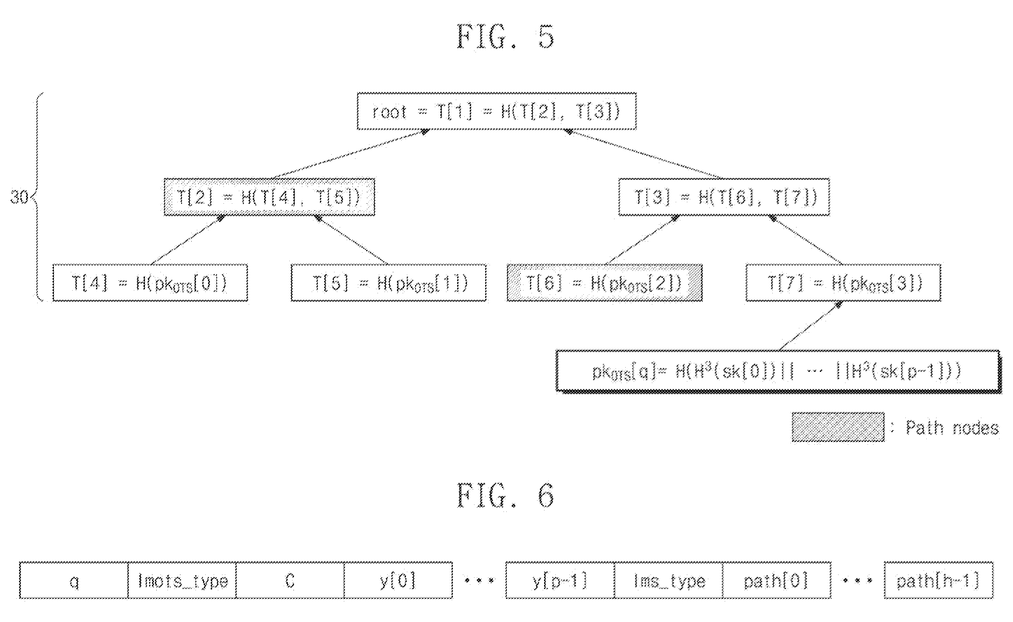

FIG. 6 is a diagram showing a structure of a signature, according to one or more embodiments of the present disclosure.

Referring to FIG. 6, a signature may include a leaf node index ‘q’, type codes lmots_type and lms_type, a hash function seed ‘C’, intermediate values y[0] to y[p-1] of a hash chain, and node values path[0] to path[h-1] of path nodes.

For example, the leaf node index ‘q’ may be a location of the leaf node used for the signature within a Merkle tree. For example, among the type codes lmots_type and lms_type, the hash chain type code lmots_type may include height information of the hash chain, and the Merkle tree type code lms_type may include height information of the Merkle tree. For example, the hash function seed ‘C’ may be input into hash chain operations to prevent signature forgery and enhance randomness. For example, as described in FIG. 4, the intermediate values y[0] to y[p-1] of the hash chain may be secret keys or intermediate values obtained by performing hash chain operations on secret keys, and may be values for generating the value of the leaf node by generating a one-time public key. For example, the node values path[0] to path[h-1] of path nodes may be values of path nodes, on which Merkle tree operations is to be performed, from a leaf node used for signature to the root node in the Merkle tree.

For example, the hash function seed ‘C’, the intermediate values y[0] to y[p-1] of the hash chain, and sizes of the node values path[0] to path[h-1] of the path nodes may be determined depending on the type codes lmots_type and lms_type. For example, when the type codes lmots_type and lms_type are the same as each other, sizes of the hash function seed ‘C’, the intermediate values y[0] to y[p-1] of the hash chain, and the node values path[0] to path[h-1] of the path nodes may be fixed.

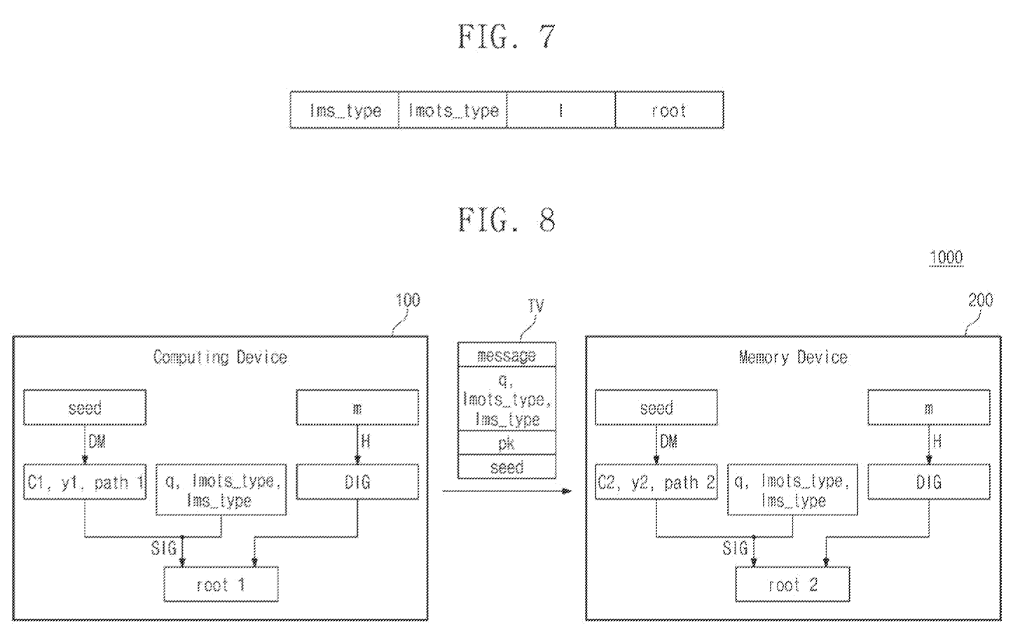

FIG. 7 is a diagram showing a structure of a public key, according to one or more embodiments of the present disclosure.

Referring to FIG. 7, the public key may include the type codes lmots_type and lms_type, an identifier ‘I’, and a root value root.

For example, the type codes lmots_type and lms_type may have the same values as the type codes lmots_type and lms_type included in the signature of FIG. 6 by a signatory. For example, the identifier ‘I’ may be a value for generating a digest by performing a hash operation on a message together. For example, the identifier ‘I’ may be a value for ensuring the uniqueness of the hash chain or Merkle tree while confusion between different signatures is prevented. For example, the root value root may be a value of the root node of a Merkle tree. For example, when generating a signature, the signatory may include the type codes lmots_type and lms_type in a public key, which are the same as the type codes lmots_type and lms_type included in the signature. For example, when generating a signature, the signatory may include the root value root, which is the same as the value of the root node in the public key of the Merkle tree. For example, when generating a signature, the signatory may include a specific value for guaranteeing the uniqueness in the public key.

FIG. 8 is a diagram illustrating a signature verification system for testing a signature verification operation, according to one or more embodiments of the present disclosure.

Referring to FIG. 8, a signature verification system 1000 may include a computing device 100 and a memory device 200. For example, referring to FIG. 1, the computing device 100 may correspond to the signatory 11, and the memory device 200 may correspond to the verifier 12.

The computing device 100 may be configured to generate data for testing a signature verification operation of the memory device 200 and to deliver (send) the data to the memory device 200. For example, the computing device 100 may be configured to deliver a test vector TV to the memory device 200. For example, the test vector TV may include the message ‘m’, the leaf node index ‘q’, the first type codes lmots_type and lms_type, the public key pk, and a seed ‘seed’.

The computing device 100 may be configured to generate the leaf node index ‘q’ and the first type codes lmots_type and lms_type. For example, the computing device 100 may be configured to generate the first type codes lmots_type and lms_type, which are the same as the type codes for the signature applied to data of the memory device 200. For example, the signature applied to data of the memory device 200 may be a signature applied to a firmware image, a software update file, a security certificate, or transaction data of the memory device 200. For example, the first type codes lmots_type and lms_type may include the hash chain type code lmots_type and the Merkle tree type code lms_type. For example, the hash chain type code lmots_type may include height information of a hash chain, and the Merkle tree type code lms_type may include height information of a Merkle tree. For example, the computing device 100 may be configured to generate the public key pk including type codes the same as the first type codes lmots_type and lms_type.

For example, the computing device 100 may be configured to generate the leaf node index ‘q’ as a random value. For example, the computing device 100 may be configured to generate the leaf node index ‘q’ as a random value based on the height information of the Merkle tree. For example, when the height of the Merkle tree is ‘h’, the computing device 100 may be configured to generate the leaf node index ‘q’ as a random value among integer values greater than or equal to 0 and less than or equal to “2^{h}-1”.

The computing device 100 may be configured to generate the message ‘m’. For example, the computing device 100 may be configured to generate a random message ‘m’. For example, the computing device 100 may be configured to generate the digest DIG by performing the hash operation ‘H’ on the message ‘m’.

The computing device 100 may be configured to generate the seed ‘seed’. For example, the computing device 100 may be configured to generate the seed ‘seed’ based on first intermediate values y1 of the hash chain, a first hash function seed C1, and a first node value path1 of the Merkle tree. For example, the computing device 100 may be configured to generate the seed based on sizes of the first intermediate values y1, the first hash function seed C1, and the first node values path1. For example, the sizes of the first intermediate values y1, the first hash function seed C1, and the first node values path1 may be determined based on the first type codes lmots_type and lms_type. For example, a hash function seed, node values, and intermediate values having the same type code may have the same size. For example, the computing device 100 may generate the seed ‘seed’ such that the first intermediate values y1, the first hash function seed C1, and the first node values path1 have sizes based on the first type codes lmots_type and lms_type. Detailed descriptions of the operation in which the computing device 100 generates the seed ‘seed’ will be described later with reference to FIG. 10.

The computing device 100 may be configured to generate the first intermediate values y1 of a hash chain, the first hash function seed C1, and the first node values path1 of a Merkle tree based on the seed ‘seed’. For example, the first hash function seed C1 may be a value input to hash chain operations. For example, the first node values path1 may be values of path nodes from a leaf node to a root node.

For example, the computing device 100 may be configured to generate the first intermediate values y1 of the hash chain, the first hash function seed C1, and the first node values path1 of the Merkle tree depending on a deterministic function (deterministic method) DM based on the seed ‘seed’. For example, the deterministic function DM may be a method that always outputs the same value for inputs of the same seed ‘seed’. For example, the first intermediate values y1 of the hash chain, the first hash function seed C1, and the first node values path1 of the Merkle tree, which are generated, may be random values. For example, unlike the illustration of FIGS. 1, 4, and 5, the first intermediate values y1 of the hash chain, the first hash function seed C1, and the first node values path1 of the Merkle tree may be values unrelated to the message. Detailed descriptions of the deterministic function DM based on the seed ‘seed’ will be described later with reference to FIG. 10.

The computing device 100 may be configured to compute the value of a first root node based on the first intermediate values y1 of the hash chain, the first hash function seed C1, the first node values path1 of the Merkle tree, the leaf node index ‘q’, the first type codes lmots_type and lms_type, and the digest DIG. For example, the computing device 100 may be configured to generate the value of a first leaf node by performing hash chain operations using the first intermediate values y1 and the first hash function seed C1 as inputs based on the hash chain type code lmots_type. For example, counts of hash chain operations may be determined based on the digest DIG. For example, the computing device 100 may be configured to generate a value root1 of the first root node by performing Merkle tree operations on the value of the first leaf node and the first node values path1 based on the Merkle tree type code lms_type and the leaf node index ‘q’. For example, the computing device 100 may be configured to generate the public key pk including a root value equal to the value root1 of the first root node.

The computing device 100 may be configured to deliver the generated test vector TV to the memory device 200. For example, the computing device 100 may be configured to deliver the test vector TV including the message ‘m’, the leaf node index ‘q’, the first type codes lmots_type and lms_type, the public key pk, and the seed ‘seed’, which are generated, to the memory device 200. For example, the computing device 100 may deliver the seed ‘seed’ to the memory device 200, but may not deliver the first intermediate values y1, the first hash function seed C1, or the first node values path1.

According to one or more embodiments, as the test vector TV does not include the first intermediate values y1, the first hash function seed C1, and the first node values path1, the size of the test vector TV may be relatively small. For example, the size of seed ‘seed’ may be smaller than each of the sizes of the first intermediate values y1, the first hash function seed C1, and the first node values path1. For example, the size of the signature SIG, which includes the first intermediate values y1, the first hash function seed C1, and the first node values path1, may be 780 to 9324 [bytes]. For example, the size of the signature SIG, which does not include the first intermediate values y1, the first hash function seed C1, and the first node values path1 but includes the seed ‘seed’, may be 2580 to 3060 [bytes].

The memory device 200 may be configured to test a signature verification operation by performing the signature verification operation on the test vector TV.

The memory device 200 may be configured to determine whether the type codes included in the public key pk are the same as the first type codes lmots_type and lms_type. For example, when the type codes included in the public key pk are the same as the first type codes lmots_type and lms_type, the memory device 200 may be configured to perform the signature verification operation on the test vector TV.

The memory device 200 may be configured to generate second intermediate values y2 of the hash chain, a second hash function seed C2, and second node values path2 of the Merkle tree based on the seed ‘seed’ included in the test vector TV. For example, the memory device 200 may be configured to generate the second intermediate values y2 of the hash chain, the second hash function seed C2, and the second node values path2 of the Merkle tree depending on the deterministic function DM based on the seed ‘seed’. For example, the memory device 200 may use the deterministic function DM the same as the computing device 100.

The memory device 200 may be configured to generate the digest DIG by performing the hash operation ‘H’ on the message ‘m’ included in the test vector TV.

The memory device 200 may be configured to generate the value root2 of the second root node through the second intermediate values y2, the second hash function seed C2, the second node values path2, the digest DIG, the leaf node index ‘q’ included in the test vector TV, and the first type codes lmots_type and lms_type included in the test vector TV. For example, the memory device 200 may be configured to generate the value of a second leaf node by performing hash chain operations using the second intermediate values y2 and the second hash function seed C2 as inputs based on the hash chain type code lmots_type. For example, counts of hash chain operations may be determined based on the digest DIG. For example, the memory device 200 may be configured to generate the value root2 of the second root node by performing Merkle tree operations on the value of the second leaf node and the second node values path2 based on the Merkle tree type code lms_type and the leaf node index ‘q’.

The memory device 200 may be configured to verify whether the generated value root2 of the second root node is the same as the root value included in the public key pk. For example, when the value root2 of the second root node is the same as the root value included in the public key pk, the memory device 200 may identify that the signature verification operation is normal. For example, when the value root2 of the second root node is not the same as the root value included in the public key pk, the memory device 200 may identify that the signature verification operation is abnormal. For example, the memory device 200 may be configured to output the result indicating whether the signature verification operation is normal.

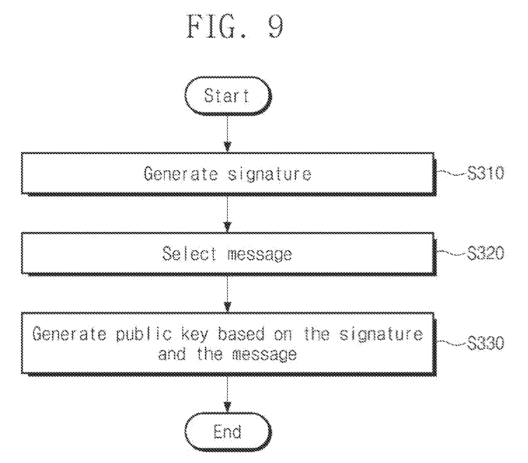

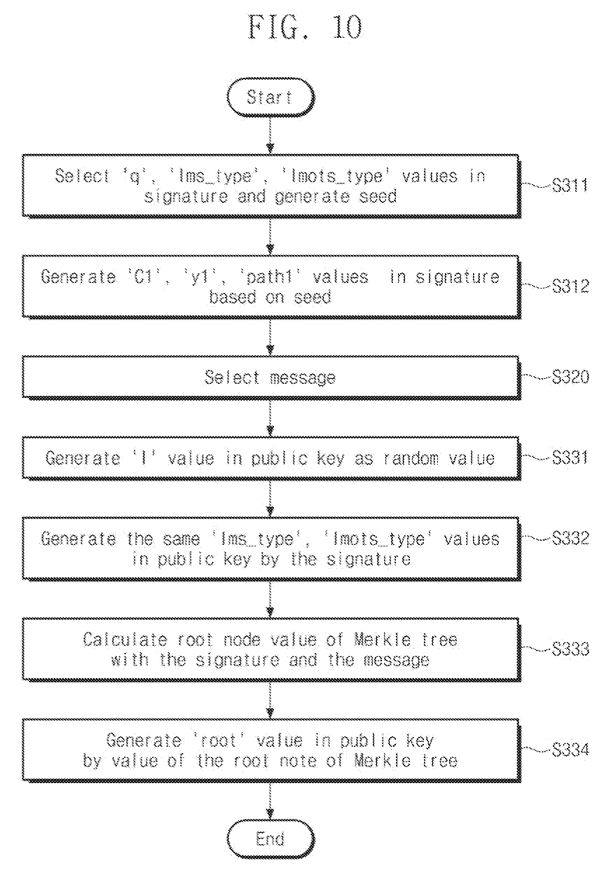

FIG. 9 is a diagram illustrating a test vector generating method, according to one or more embodiments of the present disclosure.

Referring to FIG. 8 together, in operation S310, the computing device 100 may generate the signature SIG. For example, the signature SIG may include the leaf node index ‘q’, the first type codes lmots_type and lms_type, the first intermediate values y1, the first hash function seed C1, and the first node values path1.

In operation S320, the computing device 100 may select the message ‘m’.

In operation S330, the computing device 100 may generate the public key pk based on the signature SIG and the message ‘m’. For example, the computing device 100 may generate the value root1 of the first root node through the digest DIG and the signature SIG by performing the hash operation ‘H’ on the message ‘m’. For example, the computing device 100 may generate the public key pk including the first type codes lmots_type and lms_type and a root value the same as the value root1 of the first root node.

According to one or more embodiments, the computing device 100 may first generate the signature SIG and the message ‘m’, and then may generate the public key pk. On the other hand, the signatory 11 of FIGS. 1 and 2 may first generate the secret key sk and the public key pk, and then generate the signature SIG by performing a signature operation on the message ‘m’. Accordingly, the computing device 100 may generate the signature SIG without the secret key sk, and may generate a public key based on the signature SIG.

FIG. 10 is a flowchart illustrating a test vector generating method of FIG. 9, according to one or more embodiments of the present disclosure.

Referring to FIG. 8 together, in operation S311, the computing device 100 may generate the signature SIG, including the first type codes lmots_type and lms_type, and the leaf node index ‘q’, and a seed. For example, the computing device 100 may generate the first type codes lmots_type and lms_type, which are the same as the type codes for the signature applied to data of the memory device 200. For example, the first type codes lmots_type and lms_type may include the hash chain type code lmots_type and the Merkle tree type code lms_type. For example, the computing device 100 may generate the leaf node index ‘q’ as a random value based on height information of the Merkle tree included in the Merkle tree type code lms_type. For example, the computing device 100 may generate the seed ‘seed’. For example, the computing device 100 may generate the seed ‘seed’ such that the first intermediate values y1 of a hash chain, the first hash function seed C1, and the first node values path1 of a Merkle tree have constant sizes based on the first type codes lmots_type and lms_type.

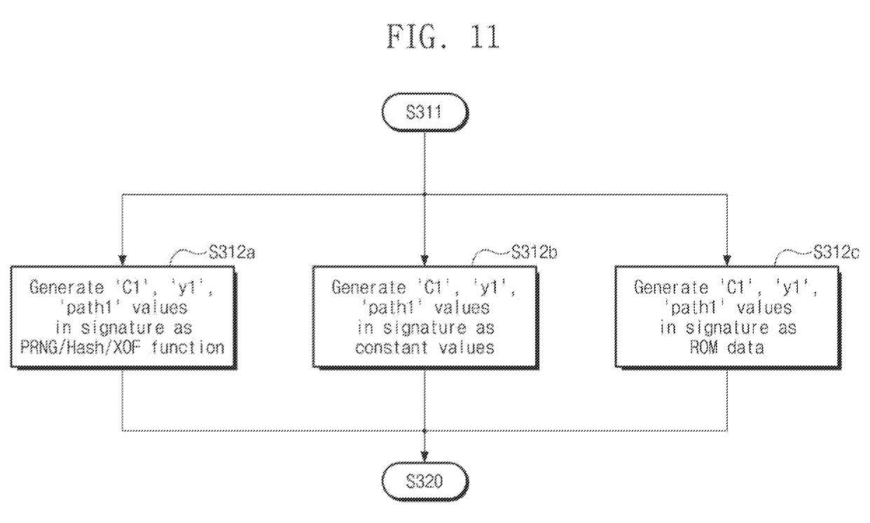

In operation S312, the computing device 100 may generate the first intermediate values y1 of a hash chain, the first hash function seed C1, and the first node values path1 of a Merkle tree based on the seed ‘seed’. For example, according to the deterministic function DM based on the seed ‘seed’, the computing device 100 may generate the first intermediate values y1, the first hash function seed C1, and the first node values path1. For example, the deterministic function DM may be a method that always outputs the same value for inputs of the same seed ‘seed’. For example, the computing device 100 may include the first intermediate values y1, the first hash function seed C1, and the first node values path1, which are generated, in the signature SIG. Detailed descriptions of the deterministic function DM will be described later with reference to FIG. 11.

In operation S320, the computing device 100 may select the message ‘m’.

In operation S331, the computing device 100 may generate an identifier as a random value. For example, the identifier may be included in a public key. For example, the computing device 100 may generate the digest DIG by performing a hash operation on the message ‘m’ and the identifier.

In operation S332, the computing device 100 may generate a public key including second type codes the same as the first type codes lmots_type and lms_type.

In operation S333, the computing device 100 may generate the value root1 of the first root node based on the signature SIG and the message ‘m’. For example, the computing device 100 may generate the value of a first leaf node by performing hash chain operations using the first intermediate values y1 and the first hash function seed C1 as inputs based on the hash chain type code lmots_type. For example, the count of hash chain operations may be determined by a value obtained by performing a hash operation on the message ‘m’ and the identifier ‘I’. For example, the computing device 100 may generate a value root1 of the first root node by performing Merkle tree operations on the value of the first leaf node and the first node values path1 based on the Merkle tree type code lms_type and the leaf node index ‘q’.

In operation S334, the computing device 100 may generate a public key including a root value the same as the value root1 of the first root node.

FIG. 11 is a diagram illustrating examples of a deterministic function based on the seed of FIG. 10, according to one or more embodiments of the present disclosure.

Referring to FIG. 10 together, the computing device 100 may perform operation S311, operation S312a, operation S312b, or operation S312c. For example, the deterministic function performed in operation S312a, operation S312b, or operation S312c may always output the same value with respect to inputs of the same seed ‘seed’.

In operation S312a, the computing device 100 may generate the first intermediate values y1, the first hash function seed C1, and the first node values path1 by using a pseudorandom number generator (PRNG) function, a hash function, or an extendable-output function (XOF), which take the seed ‘seed’ as an input.

According to one or more embodiments, the computing device 100 may generate the first intermediate values y1, the first hash function seed C1, and the first node values path1 by using the PRNG function, which takes the seed ‘seed’ as an input. For example, the PRNG function may output an input value as a random value. For example, when the input value is the same, the PRNG function may output a constant value. For example, when the seed ‘seed’ input to the PRNG function is the same, the output value of the PRNG function may always be constant. For example, the PRNG function may adjust the length of the output random value depending on the input value. For example, the computing device 100 may generate a seed depending on the output value of the PRNG function that takes the seed ‘seed’ as an input. For example, the computing device 100 may generate the seed ‘seed’ such that the first intermediate values y1, the first hash function seed C1, and the first node values path1 have sizes based on the first type codes lmots_type and lms_type. For example, the size of the output value of the PRNG function that takes the seed ‘seed’ as an input may be based on the first type codes lmots_type and lms_type.

According to one or more embodiments, the computing device 100 may generate the first intermediate values y1, the first hash function seed C1, and the first node values path1 by using a hash function taking the seed ‘seed’ as an input. For example, the hash function may output an input value as a random value. For example, when the input value is the same, the hash function may output a constant value. For example, when the seed ‘seed’ input to the hash function is the same, the output value of the hash function may always be constant. For example, a hash function may output a random value of a specific length regardless of the input value. For example, the seed ‘seed’ may include a plurality of seeds, and the computing device 100 may generate a seed depending on the output value of the PRNG function that takes the seed ‘seed’ as an input. For example, the computing device 100 may generate a plurality of seeds included in the seed ‘seed’ such that the first intermediate values y1, the first hash function seed C1, and the first node values path1 have sizes based on the first type codes lmots_type and lms_type. For example, the size of the output value of the hash function that takes the plurality of seeds as inputs may be based on the first type codes lmots_type and lms_type.

According to one or more embodiments, the computing device 100 may generate the first intermediate values y1, the first hash function seed C1, and the first node values path1 by using an extendable-output function (XOF) function, which take the seed ‘seed’ as an input. For example, the XOF function may output an input value as a random value. For example, when the input value is the same, the XOF function may output a constant value. For example, when the seed ‘seed’ input to the XOF function is the same, the output value of the XOF function may always be constant. For example, the XOF function may adjust the length of the output random value depending on the input value. For example, the computing device 100 may generate a seed depending on the output value of the XOF function that takes the seed ‘seed’ as an input. For example, the computing device 100 may generate the seed ‘seed’ such that the first intermediate values y1, the first hash function seed C1, and the first node values path1 have sizes based on the first type codes lmots_type and lms_type. For example, the size of the output value of the XOF function that takes the seed ‘seed’ as an input may be based on the first type codes lmots_type and lms_type.

In operation S312b, the computing device 100 may generate the first intermediate values y1, the first hash function seed C1, and the first node values path1 as fixed constant values based on the seed ‘seed’ being a fixed constant value. For example, when the seed ‘seed’ is 0, the computing device 100 may generate all of the first intermediate values y1, the first hash function seed C1, and the first node values path1 as ‘0’.

In operation S312c, the seed ‘seed’ may include location information for values stored in a read-only memory (ROM) of the memory device 200, and the computing device 100 may generate the first intermediate values y1, the first hash function seed C1, and the first node values path1 based on location information by using the stored values in the ROM. For example, the computing device 100 may receive values stored in the ROM of the memory device 200 based on the location information included in the seed ‘seed’. For example, the computing device 100 may determine the location information included in the seed ‘seed’ based on the sizes of the first intermediate values y1, the first hash function seed C1, and the first node values path1 based on the first type codes lmots_type and lms_type. For example, the sizes of the values stored in the ROM of the memory device 200 based on the location information included in the seed ‘seed’ may be based on the first type codes lmots_type and lms_type.

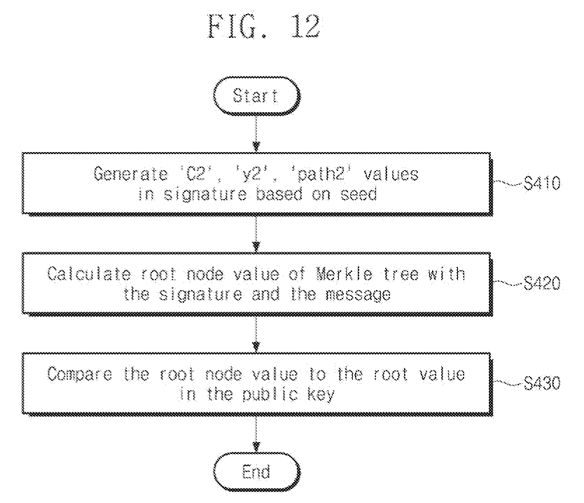

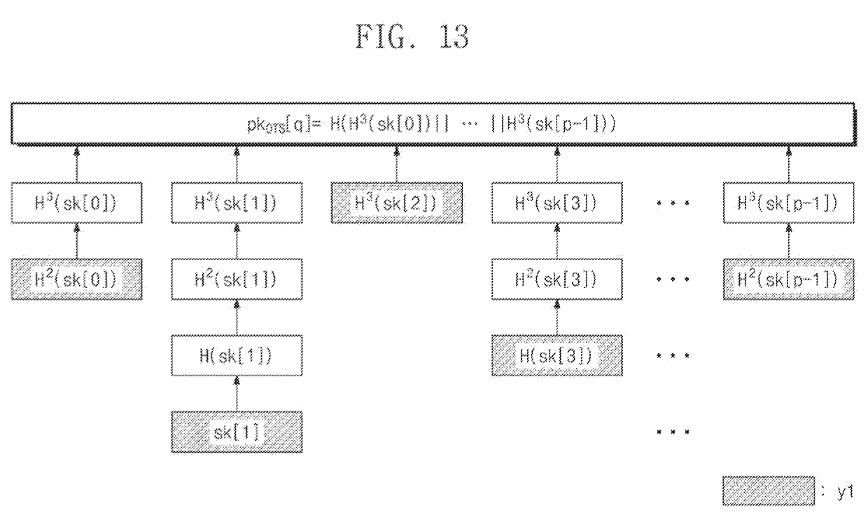

FIG. 12 is a diagram illustrating a method in which a memory device tests a signature verification operation, according to one or more embodiments of the present disclosure.

Referring to FIG. 8 together, in operation S410, the memory device 200 may generate the second intermediate values y2, the second hash function seed C2, and the second node values path2 based on the seed ‘seed’. For example, according to a deterministic function, the memory device 200 may generate the second intermediate values y2, the second hash function seed C2, and the second node values path2 based on the seed ‘seed’ included in the test vector TV. For example, the deterministic function of the memory device 200 may be the same as the deterministic function of the computing device 100. For example, when the computing device 100 uses a PRNG function, the memory device 200 may use the same PRNG function. For example, when the computing device 100 uses a hash function, the memory device 200 may use the same hash function. For example, when the computing device 100 uses the XOF function, the memory device 200 may use the same XOF function. For example, when the seed ‘seed’ is a fixed constant value, the memory device 200 uses the same seed ‘seed’ as the computing device 100, and thus the memory device 200 may use the second intermediate values y2, the second hash function seed C2, and the second node values path2 as the same fixed constant values as the computing device 100. For example, when the seed ‘seed’ is location information about values stored in a ROM of the memory device 200, the stored values in the ROM used by the computing device 100 and the memory device 200 may be the same values. That is, the first intermediate values y1 may be the same as the second intermediate values y2; the first hash function seed C1 may be the same as the second hash function seed C2; and, the first node values path1 may be the same as the second node values path2. For example, the memory device 200 may include the second intermediate values y2, the second hash function seed C2, and the second node values path2, which are generated, in the signature SIG.

In operation S420, the memory device may generate the value root2 of the second root node based on the signature SIG and the message ‘m’. The memory device may determine whether the type codes included in the public key pk are the same as the first type codes lmots_type and lms_type. For example, when the type codes included in the public key pk are the same as the first type codes lmots_type and lms_type, the memory device 200 may perform an operation of generating the value root2 of the second root node. For example, the memory device 200 may generate the value of a second leaf node by performing hash chain operations using the second intermediate values y2 and the second hash function seed C2 as inputs based on the hash chain type code lmots_type included in the test vector TV. For example, the count of hash chain operations may be determined by a value obtained by performing a hash operation on the message ‘m’ and the identifier ‘I’. For example, the memory device 200 may generate the value root2 of the second root node by performing Merkle tree operations on the value of the second leaf node and the second node values path2 based on the Merkle tree type code lms_type and the leaf node index ‘q’.

In operation S430, the memory device 200 may verify whether the value root2 of the second root node is the same as a root value included in the public key pk. For example, when the value root2 of the second root node is the same as the root value included in the public key pk, the memory device 200 may identify that the signature verification operation is normal. For example, when the value root2 of the second root node is not the same as the root value included in the public key pk, the memory device 200 may identify that the signature verification operation is abnormal. For example, the memory device 200 may be configured to output the result indicating whether the signature verification operation is normal.

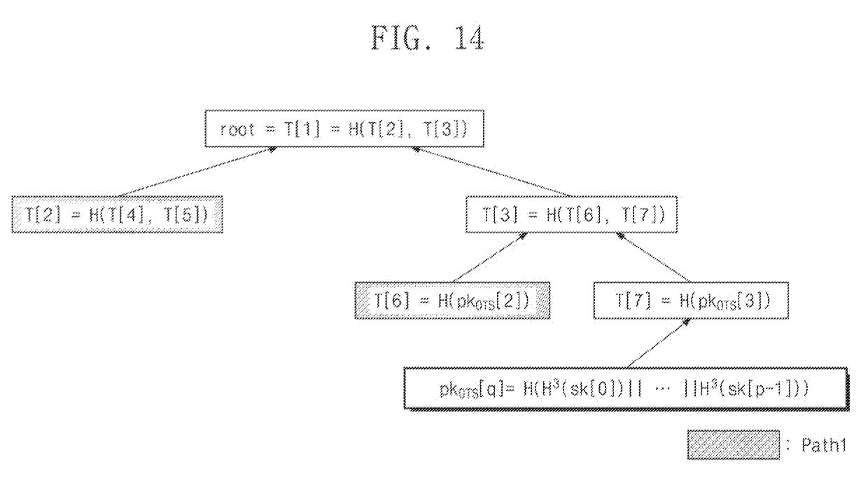

FIG. 13 is a diagram illustrating hash chain operations when the signature verification system of FIG. 8 tests a signature verification operation, according to one or more embodiments of the present disclosure.

Referring to FIG. 8 together, the signature verification system 1000 may generate a one-time public key without generating secret keys. For example, as described in FIGS. 8 to 12, the computing device 100 may generate the first intermediate values y1 of a hash chain. For example, the computing device 100 may generate the one-time public key by performing hash chain operations on the first intermediate values y1 based on the hash chain type code lmots_type and the digest DIG. Unlike the illustration of FIG. 4, the hash chain of the signature verification system 1000 may not include secret keys. Accordingly, the hash chain operations performed by the signature verification system 1000 may be smaller than the hash chain operations in FIG. 4. For example, the load of hash chain operations performed by the signature verification system 1000 may be less than the load of hash chain operations in FIG. 4.

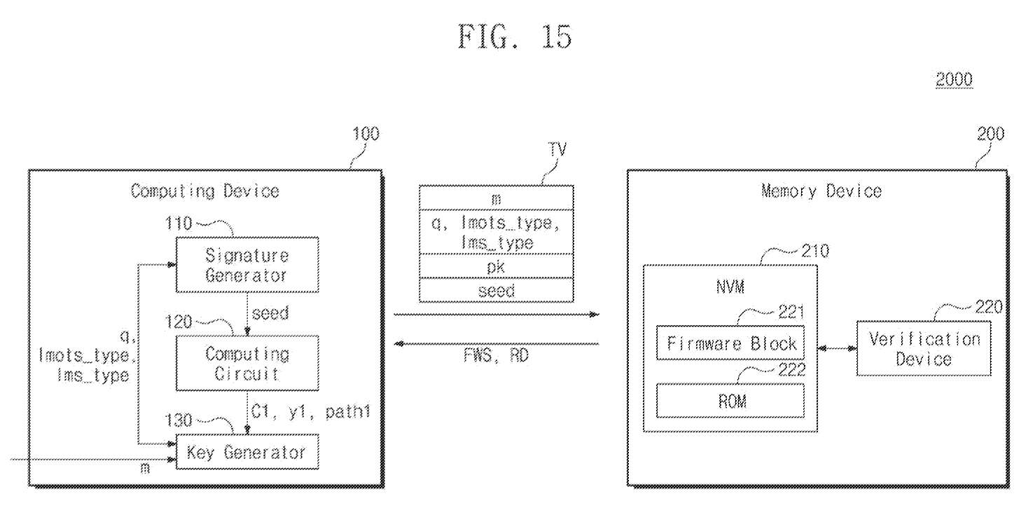

FIG. 14 is a diagram illustrating Merkle tree operations when the signature verification system of FIG. 8 tests a signature verification operation, according to one or more embodiments of the present disclosure.

Referring to FIG. 8 together, the signature verification system 1000 may generate only a leaf node according to a one-time public key and may generate a value of a root node. For example, the signature verification system 1000 may generate only a value of a first leaf node and the value root1 of a first root node. For example, as described in FIGS. 8 to 12, the computing device 100 may generate a value root1 of the first root node by performing Merkle tree operations on the value of the first leaf node and the first node values path1 based on the Merkle tree type code lms_type and the leaf node index ‘q’. Unlike the illustration of FIG. 5, the Merkle tree of the signature verification system 1000 may not include all leaf nodes. Accordingly, the Merkle tree operations performed by the signature verification system 1000 may be smaller than the Merkle tree operations in FIG. 5. For example, the load of Merkle tree operations performed by the signature verification system 1000 may be less than the load of Merkle tree operations in FIG. 5.

FIG. 15 is a diagram illustrating a firmware signature verification system 2000, according to one or more embodiments of the present disclosure.

The firmware signature verification system 2000 may include the computing device 100 and the memory device 200.

The computing device 100 may include a signature generator 110, a computing circuit 120, and a key generator 130. For example, the computing device 100 may be configured to generate the test vector TV and to deliver the test vector TV to the memory device 200. For example, the test vector TV may include the message ‘m’, a signature (q, lmots_type, and lms_type), the public key pk and the seed ‘seed’. For example, the test vector TV may not include first data (C1, y1, and path1).

The signature generator 110 may be configured to generate the signature (q, lmots_type, and lms_type) and the seed ‘seed’. For example, the signature generator 110 may be configured to generate the signature (q, lmots_type, and lms_type) including the leaf node index ‘q’ and the first type codes lmots_type and lms_type. For example, the leaf node index ‘q’ may include location information of a leaf node computed through the test vector TV. For example, the first type codes lmots_type and lms_type may include height information of a hash chain and height information of a Merkle tree. For example, the signature generator 110 may receive firmware signature-related information FWS from a firmware block 221. For example, the firmware signature-related information FWS may include type codes of a firmware signature applied to the firmware of a non-volatile memory 210. For example, the first type codes lmots_type and lms_type may be the same as the type codes for the firmware signature.

For example, the signature generator 110 may be configured to generate the seed ‘seed’ based on a size of the first data (C1, y1, and path1). For example, the signature generator 110 may be configured to determine the size of the first data (C1, y1, and path1) based on the first type codes lmots_type and lms_type included in the signature (q, lmots_type, and lms_type).

According to a deterministic function based on the seed ‘seed’, the computing circuit 120 may be configured to compute the first data (C1, y1, and path1). For example, the deterministic function may be a method that always outputs the same value for inputs of the same seed ‘seed’. For example, the deterministic function performed by the computing circuit 120 may be a method of using one of a PRNG function, a hash function, and a XOF function based on the seed ‘seed’. For example, the computing circuit 120 may generate the first data (C1, y1, and path1) as a fixed constant value. For example, the computing circuit 120 may receive location information RD of values stored in a ROM 222. For example, the computing circuit 120 may generate the first data (C1, y1, and path1) as values stored in the ROM 222. For example, the computing circuit 120 may be configured to use the same deterministic function of FIG. 11. For example, the first data (C1, y1, and path1) may include the first intermediate values y1 of hash chains, the first hash function seed C1, and the first node values path1 of the Merkle tree.

The key generator 130 may be configured to compute a first root value based on the message ‘m’, the signature (q, lmots_type, and lms_type), and the first data (C1, y1, and path1), which are received from an external device, and to generate the public key pk including the first root value. For example, as shown in FIGS. 10 and 12, the key generator 130 may be configured to compute the first root value by performing hash chain operations and Merkle tree operations based on the first data (C1, y1, and path1). For example, the key generator 130 may be configured to generate a value of a first leaf node by performing hash chain operations based on the first type codes lmots_type and lms_type, by taking the first intermediate values y1 and the first hash function seed C1 as inputs. For example, the key generator 130 may determine counts of hash chain operations based on a value obtained by performing the hash operation on the message ‘m’. For example, the key generator 130 may be configured to compute a first root value by performing Merkle tree operations on the value of the first leaf node and the first node values path1 based on the leaf node index ‘q’ and the first type codes lmots_type and lms_type.

The key generator 130 may generate the public key pk including type codes the same as the first type codes lmots_type and lms_type.

The memory device 200 may include the non-volatile memory 210 and a verification device 220.

The non-volatile memory 210 may include the firmware block 221 and the ROM 222. For example, the firmware block 221 may be configured to transmit the firmware signature-related information FWS to the computing device 100 at the request of the computing device 100. For example, the ROM 222 may be configured to transmit the location information RD of the stored values at the request of the computing device 100.

The non-volatile memory 210 may be configured to receive and store the test vector TV. For example, the test vector TV may include the message ‘m’, a signature (q, lmots_type, and lms_type), the public key pk and the seed ‘seed’. For example, the non-volatile memory 210 may be configured to provide the stored test vector TV to the verification device 220.

The verification device 220 may be configured to receive the test vector TV from the non-volatile memory 210, to perform a signature verification operation, and to test the signature verification operation. For example, the verification device 220 may be configured to determine whether the first type codes lmots_type and lms_type included in the signature (q, lmots_type, and lms_type) are the same as the type codes included in a public key. For example, the verification device 220 may be configured to perform a signature verification operation based on a response indicating that the first type codes lmots_type and lms_type included in the signature (q, lmots_type, and lms_type) are the same as the type codes included in the public key.

For example, the verification device 220 may be configured to compute second data depending on a deterministic function based on the seed ‘seed’ stored in the non-volatile memory 210. For example, the deterministic function of the verification device 220 may be the same as the deterministic function of the computing circuit 120.

For example, the verification device 220 may be configured to compute a second root value based on the signature (q, lmots_type, and lms_type), the message ‘m’, and the second data, which are stored in the non-volatile memory 210. For example, the second data may include second intermediate values of hash chains, a second hash function seed, and second node values of the Merkle tree. For example, the verification device 220 may be configured to generate the value of a second leaf node by performing hash chain operations, which take the second intermediate values and the second hash function seed as inputs, based on the first type codes lmots_type and lms_type. For example, the verification device 220 may determine counts of hash chain operations through a value obtained by performing the hash operation on the message ‘m’. For example, the verification device 220 may be configured to compute the a second root value by performing Merkle tree operations on a value of the second leaf node and the second node values based on the leaf node index ‘q’ and the first type codes lmots_type and lms_type.

For example, the verification device 220 may be configured to determine whether the signature verification operation is successful, by determining whether the second root value is the same as the first root value included in the public key pk. For example, when the second root value is the same as the first root value, the verification device 220 may determine that the signature verification operation is normal. For example, when the second root value is not the same as the first root value, the verification device 220 may determine that the signature verification operation is abnormal. For example, the verification device 220 may be configured to output the result indicating whether the signature verification operation is normal.

According to one or more embodiments, the test vector TV of the firmware signature verification system 2000 may not include intermediate values of a hash chain, a hash function seed, and node values of the Merkle tree. On the other hand, the test vector TV may include the seed ‘seed’. As the test vector TV includes the seed ‘seed’ instead of the intermediate values of the hash chain, the hash function seed, and the node values of the Merkle tree, the size of the test vector TV stored in the non-volatile memory 210 may be reduced.

According to one or more embodiments, the verification device 220 may be configured to test a signature verification operation before the memory device 200 executes firmware. For example, the verification device 220 may be configured to identify the reliability of the signature verification operation by testing the signature verification operation. For example, when a problem occurs in the memory device 200, the verification device 220 may be configured to test the signature verification operation. For example, when the signature verification operation is determined as being normal, the verification device 220 may determine that there is a problem with the firmware of the memory device 200. For example, when the signature verification operation is determined as being abnormal, the verification device 220 may determine that a problem has occurred in the hardware or software performing the signature verification operation of the memory device 200.

As used in this specification, the terms “device” or “unit” may be physically implemented by analog and/or digital circuits including one or more of a logic gate, an integrated circuit, a microprocessor, a microcontroller, a memory circuit, a passive electronic component, an active electronic component, and the like.

The above description refers to detailed embodiments for carrying out the present disclosure. The present disclosure may include embodiments in which a design is changed simply or which are easily changed, as well as the embodiments described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to one or more embodiments of the present disclosure, a test method may generate intermediate values of a hash chain, a hash function seed, and node values of path nodes of a Merkle tree in a deterministic function based on a seed by a computing device. A public key including a root value the same as the value of a root node may be generated by performing hash chain operations and Merkle tree operations on the intermediate values, a hash function seed, and node values, As a computing device only delivers the seed to a memory device, while not storing the intermediate values of the hash chain, the hash function seed, and the node values of the path nodes of the Merkle tree, the memory device may generate them during a test operation of a signature verification operation. The test method generates a test vector for minimizing the size increase in firmware and performs signature verification on the test vector.

Embodiments of the method and device described herein improve the functioning of a computer by decreasing computer resource consumption by reducing signature size and processor requirements in encryption/decryption. These problems are present in the realm of computation and networks. Thus, embodiments herein are rooted in computer technology to overcome a problem arising in the realm of computer networks.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of testing a signature verification system comprising a computing device and a memory device, the method comprising:
generating, by the computing device, a seed and a signature comprising first type codes and a leaf node index, wherein the first type codes comprise height information of a hash chain and height information of a Merkle tree;
generating, by the computing device, first intermediate values of the hash chain, a first hash function seed, and first node values of the Merkle tree using a deterministic function, based on the seed;
generating, by the computing device, a message;
performing, by the computing device, a hash operation on the message;
generating, by the computing device, a value of a first leaf node by performing hash chain operations, wherein the hash chain operations take the first intermediate values and the first hash function seed as inputs, and wherein counts of the hash chain operations are determined based on a value obtained by performing the hash operation on the message;
generating, by the computing device, a value of a first root node by performing Merkle tree operations on the value of the first leaf node and the first node values based on the leaf node index;
generating, by the computing device, a public key comprising a root value identical to the value of the first root node; and
providing, by the computing device, the signature, the message, and the public key to the memory device.

2. The method of claim 1, wherein the generating the public key comprises:
generating an identifier as a random value, wherein the counts of the hash chain operations are determined based on a value obtained by performing the hash operation on the identifier and the message;
generating second type codes identical to the first type codes; and
generating the public key comprising the root value, the identifier, and the second type codes.

3. The method of claim 1, wherein the first type codes are identical to type codes for a signature applied to firmware of the memory device.

4. The method of claim 1, further comprising:
performing, by the memory device, a signature verification operation based on the signature, the message, and the public key.

5. The method of claim 4, wherein the performing the signature verification operation comprises:
generating, by the memory device, second intermediate values, a second hash function seed, and second node values using the deterministic function, based on the seed;
generating, by the memory device, a value of a second leaf node by performing the hash chain operations, wherein the hash chain operations take the second intermediate values and the second hash function seed as inputs, and wherein the counts of the hash chain operations are determined based on the value obtained by performing the hash operation on the message;
generating, by the memory device, a value of a second root node by performing the Merkle tree operations on the value of the second leaf node and the second node values based on the leaf node index; and
verifying, by the memory device, whether the value of the second root node is identical to the root value.

6. The method of claim 5, wherein the first intermediate values are identical to the second intermediate values,
wherein the first hash function seed is identical to the second hash function seed, and
wherein the first node values are identical to the second node values.

7. The method of claim 1, wherein the deterministic function uses a pseudorandom number generator (PRNG) function, a hash function, or an extendable-output function (XOF) based on the seed.

8. The method of claim 1, wherein the seed is a fixed value, and
wherein the deterministic function generates the first intermediate values, the first hash function seed, and the first node values as the fixed value.

9. The method of claim 4, wherein the seed comprises location information about values stored in a read-only memory (ROM) of the memory device, and
wherein the deterministic function uses the stored values of the ROM based on the location information.

10. A signature verification system comprising:
a signature generator configured to generate a seed and a signature;
a computing circuit configured to generate first data using a deterministic function, based on the seed;
a key generator configured to:
determine a first root value based on a message, the signature, and the first data; and
generate a public key comprising the first root value;
a non-volatile memory configured to store the seed, the signature, the message, and the public key; and
a verification device configured to:
receive the seed, the signature, the message, and the public key from the non-volatile memory;
determine second data using the deterministic function, based on the seed;
determine a second root value based on the signature, the message, and the second data; and
determine whether a signature verification operation is normal, based on whether the second root value is identical to the first root value in the public key.

11. The signature verification system of claim 10, wherein the signature further comprises a leaf node index, and first type codes comprising height information of a hash chain and height information of a Merkle tree,
wherein the public key further comprises second type codes identical to the first type codes,
wherein the first data comprises first intermediate values of the hash chain, a first hash function seed, and first node values of the Merkle tree, and
wherein the key generator is further configured to:
generate a value of a first leaf node by performing hash chain operations, wherein the hash chain operations take the first intermediate values and the first hash function seed as inputs, and wherein counts of the hash chain operations are determined by performing a hash operation on the message; and
compute the first root value by performing Merkle tree operations on the value of the first leaf node and the first node values based on the leaf node index.

12. The signature verification system of claim 11, wherein the non-volatile memory comprises a firmware signature applied to firmware, and
wherein the first type codes are identical to type codes for the firmware signature.

13. The signature verification system of claim 11, wherein the verification device is further configured to:
determine whether the first type codes are identical to the second type codes; and
perform the signature verification operation based on the first type codes being identical to the second type codes.

14. The signature verification system of claim 11, wherein the second data comprises second intermediate values of the hash chain, a second hash function seed, and second node values of the Merkle tree, and
wherein the verification device is further configured to:
generate a value of a second leaf node by performing the hash chain operations, wherein the hash chain operations take the second intermediate values and the second hash function seed as inputs, and wherein the counts of the hash chain operations are determined by performing the hash operation on the message; and
determine the second root value by performing the Merkle tree operations on the value of the second leaf node and the second node values based on the leaf node index.

15. The signature verification system of claim 10, wherein the deterministic function uses a pseudorandom number generator (PRNG) function, a hash function, or an extendable-output function (XOF) based on the seed.

16. The signature verification system of claim 10, wherein the seed is a fixed value, and
wherein the deterministic function generates the first data and the second data as the fixed value.

17. The signature verification system of claim 10, wherein the non-volatile memory comprises a read-only memory (ROM),
wherein the signature generator is further configured to:
receive location information about stored values stored in the ROM; and
generate the seed, and
wherein the deterministic function uses the stored values of the ROM.

18. A computing device comprising:
a signature generator configured to generate a seed and a signature comprising first type codes and a leaf node index;
a computing circuit configured to use a deterministic function to generate first intermediate values, a first hash function seed, and first node values of path nodes, based on the seed; and
a key generator configured to:
generate a value of a first leaf node by performing hash chain operations, wherein the hash chain operations take the first intermediate values and the first hash function seed as inputs, based on the first type codes;
generate a value of a first root node by performing Merkle tree operations on the value of the first leaf node and the first node values based on the first type codes and the leaf node index; and
generate a public key comprising a root value identical to the value of the first root node.

19. The computing device of claim 18, wherein the deterministic function uses a pseudorandom number generator (PRNG) function, a hash function, or an extendable-output function (XOF) based on the seed.

20. The computing device of claim 18, wherein the seed is a fixed value, and
wherein the deterministic function generates the first intermediate values, the first hash function seed, and the first node values as the fixed value.
